(19) United States
(12) Patent Application Publication
(10) Pub. No.: US 2005/0198772 A1
(43) Pub. Date: Sep. 15, 2005

(54) Water-preventing grommet for pull chain switch

(76) Inventor: Jen Kuan Liao, Daya Township (TW)

Correspondence Address: Liao Jen Kuan, 4F.-8, No. 123, Sec. 3, Taijunggang Rd., Shituen Chiu, Taichung, 407, TW

(21) Appl. No.: 10/796,076

(22) Filed: Mar. 10, 2004

(51) Int. Cl. F16L 5/02

(52) U.S. Cl. 16/2.2

(57) ABSTRACT

A water-preventing grommet for a pull chain switch has a cylindrical body with an abutting end and an inclined distal end, a recess defined in the abutting end, a downward passage defined in the inclined distal end to communicate with the recess. The inclined distal end has a flat inclined face, a top extending portion and a bottom guiding portion. The downward passage in the inclined distal end extends to the bottom guiding portion. When the grommet is placed in at a right position, the top extending portion shades the downward passage from rain drops. Meanwhile, the downward passage also eliminates water up-flow to keep water away from the pull chain switch.

### FIELD OF THE INVENTION

The present invention relates to a grommet for a pull chain switch, and more particularly to a grommet that prevents water entering into the pull chain switch.

### DESCRIPTION OF RELATED ART

Pull chain switch is commonly used on electric appliances, especially for ceiling fans, ceiling lights, or other electric appliances suspended at high places, to conveniently control an on/off operation, a brightness operation, or a speed-controlling operation etc. With reference to FIG. 5, a pull chain switch (not shown) is attached to a switch housing 20 on a ceiling fan (not shown). The switch housing 20 has a connecting tube 22 with a passage 24 formed on an outer periphery of the switch housing 20. The pull chain switch is accommodated inside the switch housing 20 and has a bead-chain 26 extending out of the switch housing 20 via the passage 24 of the connecting tube 22. In order to smooth the operation of pull chain switch, a grommet 30 in accordance with the prior art is detachably mounted on the connecting tube 22 to extend a longitudinal distance of pulling the bead-chain 26.

The grommet 30 has an abutting end 32 with a recess (not numbered), a distal end (not numbered) with a flat edge 34 and a longitudinal hole 36. The abutting end 32 attaches to the switch housing 20 by receiving the connecting tube 22 inside the recess by means of wedging or screwing. When the grommet 30 mounted on the switch housing 20, the longitudinal hole 36 aligns to the passage 24 of the connecting tube 22 to further extend the longitudinal distance of the bead-chain 26.

However, the conventional grommet 30 has some drawbacks as follows:

1. Water easily enters the longitudinal hole 36 and then enters into the switch housing 20 along the bead-chain 26 so that the pull chain switch is easily damped with water to cause malfunction to the ceiling fan.

2. The operation of pulling the bead-chain 26 is not smooth because the longitudinal hole 36 causes a right angle at the flat edge 34 on the distal end of the grommet, wherein the bead-chain 26 is easily jammed with the right angle at intervals between two beads and is easily worn out by friction of rubbing against the right angle.

The present invention provides a modified grommet to mitigate or obviate the disadvantages of the conventional grommet for the pull chain switch.

### SUMMARY OF THE INVENTION

The first objective of the present invention is to provide a water-preventing grommet for a pull chain switch, which efficiently keeps water out of the pull chain switch to avoid malfunction.

The second objective of the present invention is to provide a water-preventing grommet for a pull chain switch, which smoothes operations of the pull chain switch.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention and the detailed description of the preferred embodiment in addition to the scope of the invention defined by the claims taken in conjunction with the accompanying drawings.

### BRIEF DESCRIPTION OF THE DRAWINGS

FIG. 1 is an exploded perspective view of a water-preventing grommet for a pull chain switch in accordance with the present invention, wherein the grommet is operationally illustrated in combination with a ceiling fan;

FIG. 2 is an enlarged perspective view of the water-preventing grommet in FIG. 1;

FIG. 3 is a partially cross-sectional perspective view of the water-preventing grommet in FIG. 2;

FIG. 4 is an operationally cross-sectional side plane view of the water-preventing grommet in FIG. 1, wherein water is kept away from the pull chain switch; and

FIG. 5 is an operationally cross-sectional side plane view of a conventional grommet in accordance with the prior art, wherein water easily enters a switch housing to damp the pull chain switch.

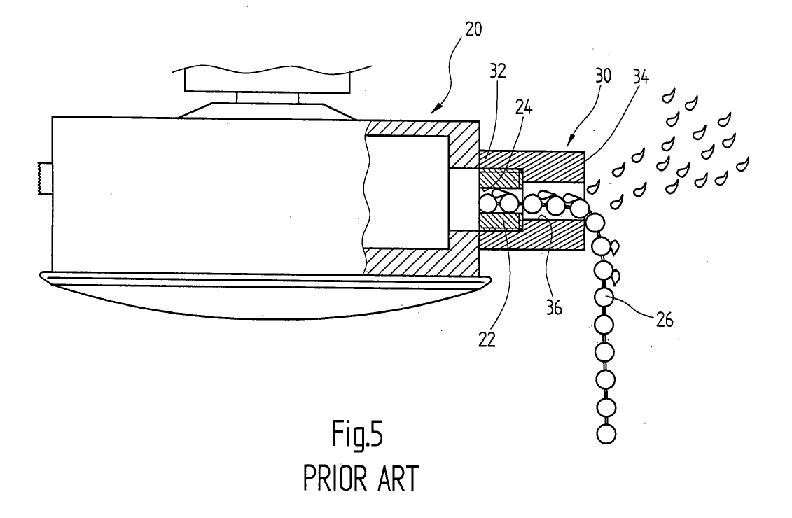

### DETAILED DESCRIPTION OF THE PREFERRED EMBODIMENT

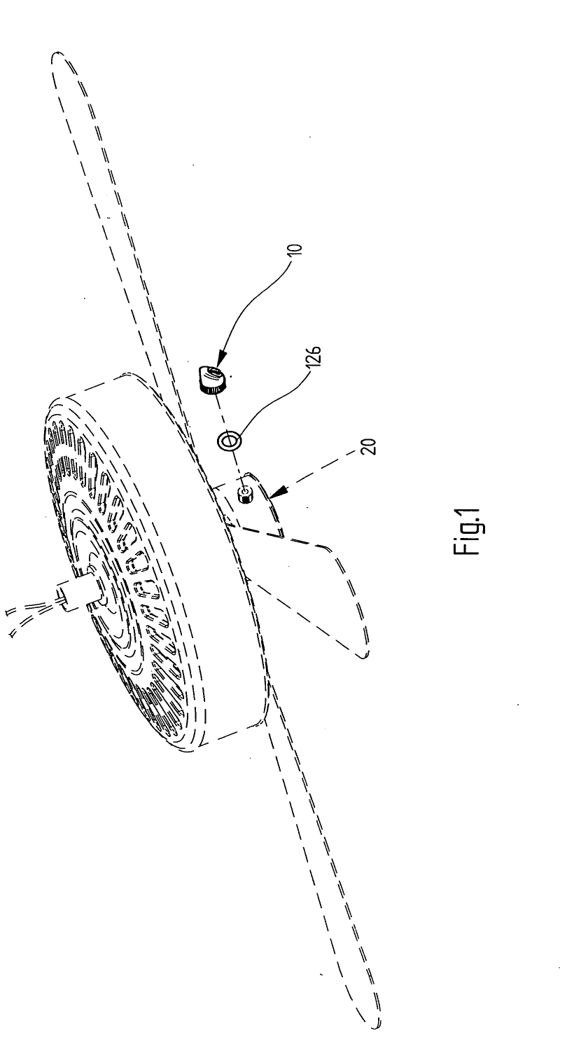

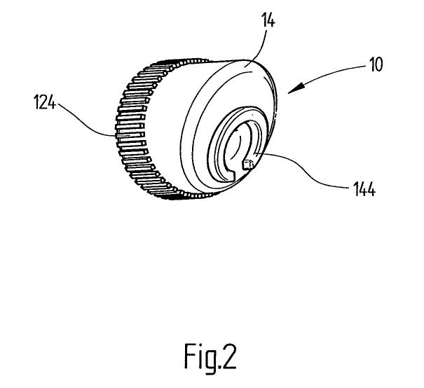

As shown in FIGS. 1 to 3, a water-preventing grommet for a pull chain switch in accordance with the present invention comprises a body 10 with an abutting end 12 and an inclined distal end 14, a recess 12, a downward passage 142, an optional C-shaped flange 144, an optional O-ring 126, and multiple optional ribs 124. Wherein, the grommet is adapted to be detachably mounted a connecting tube 22 on a switch housing 20 as described in the description of the related art.

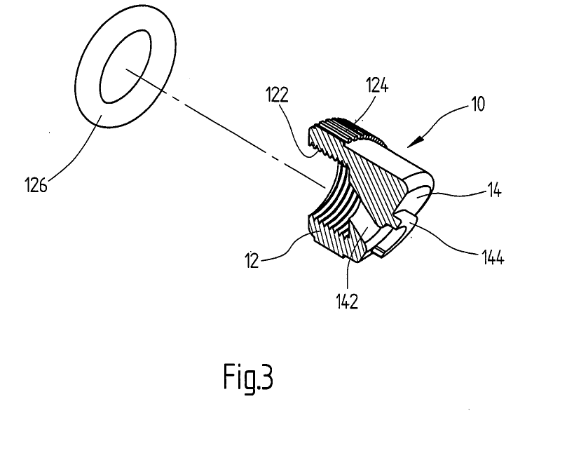

The body 10 is a cylinder with two opposite ends, respectively the abutting end 12 and the inclined distal end 14. The recess 122 is defined in the abutting end 12 and adapted to receive the connecting tube 22 to combine the body 10 and the connecting tube 22 together. Engagement of the recess 122 and the connecting tube 22 can be achieved by means of force interference. However, in a preferred embodiment as shown in FIG. 3, the recess 122 further has a threaded inner periphery and the connecting tube 22 has a threaded outer periphery (not numbered) so that the engagement can be achieved by means of screwing. Additionally, the abutting end 12 further has an outer periphery (not numbered) and multiple ribs 124 longitudinally formed on the outer periphery so that a user can easily holds and rotates the grommet.

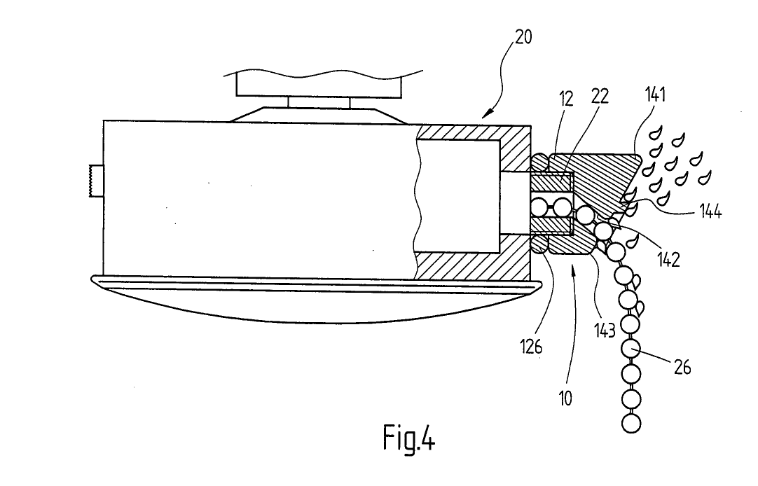

With further reference to FIG. 4, the inclined distal end 14 of the body 10 has a flat distal face (not numbered), an upper extending portion 141 and a lower guiding portion 143 opposite to the upper extending portion 141. The downward passage 142 is defined through the inclined distal end 14 to communicate to the recess 122 in the abutting end 12 and extends to the lower guiding portion 143 to define an opening (not numbered) on the flat distal face. Preferably, the inclined distal end 14 further has the C-shaped flange 144 formed on the flat distal face around the opening, wherein the C-shaped flange has its gap facing downward.

The O-ring 126 attaches to the abutting end 12 and is clamped between the body 10 and an outer periphery of the switch housing 20 when the grommet is mounted on the switch housing 20. Because the grommet has to be mounted on the connecting tube 22 at a correct location where the upper extending portion 141 must be the top over the lower guiding portion 143, therefore, the O-ring 126 provides a flexible capability to allow further rotating the body 10 until the grommet is at the correct location. Wherein, the downward passage 142 extends down when the grommet is at the correct location.

With reference to FIG. 4 again, when the water-preventing grommet for a pull chain switch mounts on the switch housing 20, a bead-chain 26 extends out of the switch housing 20 and passes through the downward passage 142. As shown in FIG. 4, the opening of the downward passage 142 is shaded by the top extending portion 141 to keep rain drops away from the opening. Meanwhile, the C-shaped flange 144 also repels water even when rain drops fall on the inclined flat face of the inclined distal end. The downward passage 122 also provides a water-preventing efficiency to the pull chain switch because water can not resist the gravity to flow upward to enter the switch housing 20. Therefore, the grommet provides an excellent water-preventing efficiency to the pull chain switch inside the switch housing 20. Additionally, the downward passage 122 eliminates right angle that blocks the bead-chain 26 as described in the conventional grommet so that the bead-chain 26 enables to be operated smoothly.

The present invention includes that contained in the appended claims, as well as that of the foregoing description. Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

1. A water-preventing grommet for a pull chain switch, the water-preventing grommet adapted to attach to a connecting tube on a switch housing and comprising:
a body 10 with an abutting end 12 and an inclined distal end 14, wherein, the inclined distal end 14 of the body 10 has a flat distal face, and upper extending portion 141 and a lower guiding portion 143 opposite to the upper extending portion 141;
a recess 122 defined in the abutting end 12 for receiving the connecting tube, the recess 122 having a threaded inner periphery for being connected to the connecting tube by rotating the body 10;
a downward passage 142 defined in the inclined distal end 14, communicated with the recess 122, and extending to the lower guiding portion 143, wherein the downward passage 142 defined an opening on the inclined flat face;
a C-shaped flange 144 formed on the flat distal face around the openings the C-shaped flange repelling water even when rain drops fall on the inclined flat face; and
an O-ring 126 attached to the abutting end 12 and clamped between the body and an outer periphery of the switch housing 20 when the grommet is mounted on the switch housing 20, thereby the O-ring provided a flexible capability to allow further rotating the body 10 until the grommet is at a correct location and the downward passage 142 extends down when the grommet is at the correct location.

2. (canceled)

3. (canceled)

4. (canceled)

5. The water-preventing grommet as claimed in claim 1, wherein the abutting end 12 further has an outer periphery and multiple ribs 124 longitudinally formed on the outer periphery of the abutting end 12.

6. (canceled)

7. (canceled)
